(19) United States
(12) Patent Application Publication
(10) Pub. No.: US 2009/0182750 A1
(43) Pub. Date: Jul. 16, 2009

(54) SYSTEM AND METHOD FOR FLASH FOLDER ACCESS TO SERVICE METADATA IN A METADATA REPOSITORY

(75) Inventors: David S. Keyes, Clinton, OH (US); Dennis M. Chin, Stow, OH (US); Catherine Betz Lippert, Solon, OH (US); Charles M. Stack, Cleveland, OH (US); Adam J. Wallace, Mentor, OH (US)

Correspondence Address: Fliesler Meyer LLP, 650 California Street, 14th Floor, San Francisco, CA, 94108, US

(73) Assignee: ORACLE INTERNATIONAL CORPORATION, Redwood Shores, CA (US)

(21) Appl. No.: 12/270,118

(22) Filed: Nov. 13, 2008

Related U.S. Application Data
(60) Provisional application No. 60/987,689, filed on Nov. 13, 2007.

(51) Int. Cl. G06F 17/30; G06F 9/44; G06F 7/00

(52) U.S. Cl. 707/10; 719/328; 707/102; 707/204; 707/E17.032; 707/E17.044; 707/E17.01

(57) ABSTRACT

Embodiments are systems and methods for automatic submission of service metadata files into a metadata repository by utilizing a protocol for web-based distributed authoring and versioning to expose a folder as a virtual view of a categorization in a hierarchy of categorizations in a metadata repository. After a service metadata file is submitted to the folder, the system automatically introspects the service metadata file to identify service information, and then the system automatically creates a service asset in the metadata repository.

### CLAIM OF PRIORITY

The present application claims the benefit of priority under 35 U.S.C. §119(e) to U.S. Provisional Patent Application No. 60/987,689 entitled “SYSTEM AND METHOD FOR FLASH FOLDER ACCESS TO SERVICE METADATA IN A METADATA REPOSITORY,” filed on Nov. 13, 2007, which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the present invention are in the field of Service-Oriented Architecture, and relate to ubiquitous access to service metadata stored in a metadata repository.

### BACKGROUND OF THE INVENTION

Service-Oriented Architecture (SOA) is based on the deconstruction of yesterday's monolithic applications and information technology infrastructure into a matrix of discrete, standards-based, network-accessible services. The process of transformation requires the organization, identification, and repurposing of applications and business processes of the existing information technology infrastructure. The transformation to SOA begins with an analysis of the IT infrastructure to identify applications, business processes, and other software assets that become services, or otherwise support the SOA.

Metadata is data about data, or more specifically, information about the content of the data. Service metadata is information about the services in an SOA. Service producers use service metadata to describe what service consumers need to know to interact with the service producers. Service metadata is stored in a metadata repository by service producers and then accessed by service consumers. A metadata repository provides visibility into the portfolio of assets, the traceability of the assets within that portfolio, the relationships and interdependencies that connect the assets to each other, the policies that govern use of the assets, and the projects that produce the assets and consume the assets.

### SUMMARY OF THE INVENTION

Embodiments are systems and methods for automatic submission of service metadata files into a metadata repository by utilizing a protocol for web-based distributed authoring and versioning to expose a folder as a virtual view of a categorization in a hierarchy of categorizations in a metadata repository. After a service metadata file is submitted to the folder, the system automatically introspects the service metadata file to identify service information, and then the system automatically creates a service asset in the metadata repository.

### BRIEF DESCRIPTION OF THE DRAWINGS

Preferred embodiments of the present invention will be described in detail based on the following figures, wherein:

FIG. 1 illustrates a system architecture diagram, in accordance with one embodiment.

FIG. 2 illustrates a system architecture diagram, in accordance with one embodiment.

FIG. 3 illustrates a flowchart for a method, in accordance with one embodiment.

FIG. 4 illustrates a flowchart for a method, in accordance with one embodiment.

FIG. 5 illustrates a system architecture diagram, in accordance with one embodiment.

FIG. 6 is a hardware block diagram of an example computer system, which may be used to embody one or more components, in accordance with one embodiment.

### DETAILED DESCRIPTION OF THE INVENTION

A metadata repository is the enterprise system of record for the software asset portfolio. The metadata repository federates metadata from individual registries and repositories. It manages all software assets and their relationships, including business processes, applications, patterns, frameworks, services and components (corporate, packaged or open source). The metadata repository has links to content in other systems (source code management systems, project portfolio management systems, document management systems, etc.) and exposes a web-service-based API for integration. The metadata repository promotes enterprise visibility and access. In one embodiment, additional features include web-based accessibility with role-based access control, a “transparent” development experience, and project portfolio management integration.

The metadata repository enables governance and compliance initiatives within an organization. A metadata repository enables automated tracking of compliance with architecture standards and regulatory requirements. A metadata repository provides for prescriptive reuse and policy, validation, certification and approvals for registered content.

In one embodiment, the metadata repository provides an analytics capability, wherein users can automatically calculate the value of the software asset portfolio, savings from use and reuse of assets, software investment return on investment (ROI), and impact analysis for IT planning decisions.

In one embodiment, the metadata repository is an enterprise repository that links multiple repositories together. The metadata repository integrates with project portfolio management systems such as CA Clarity™ and Mercury ITG. The metadata repository brings visibility of the asset portfolio and aligns it with the project portfolio. The metadata repository integrates with document management systems because frequently documentation, requirements, etc. are managed within document management repositories but need to be accessed from the asset entry within the metadata repository. The metadata repository integrates with source code management systems for code and artifacts, with build tools to harvest assets and update the status of assets. The metadata repository captures business processes and metadata through Business Process Execution Language (BPEL) introspection. The metadata repository supports the Application Programming Interfaces (APIs) for Universal Description, Discovery and Integration (UDDI) for interoperability. For organizations that have UDDI registries, the metadata repository inter-operates with UDDI registries. The metadata repository can sit on top of Systinet or any other UDDI compliant registry and bring service metadata into the metadata repository where it can be augmented and tied into the balance of the information technology ecosystem. One embodiment of the metadata repository integrates with modeling tools including Microsoft Visio . One embodiment integrates with modeling tools such as AriSTM, Popkin, and Troux.

In one embodiment, the metadata repository provides greater capabilities than just storing metadata. The metadata repository functions as a software asset management platform. It enables organizations to improve governance of the asset portfolio, enable compliance with both enterprise architecture and project-specific objectives, and provide a platform to reduce and manage complexity to lower costs and increase business agility.

Microsoft® WebFolders provides an abstract user interface that hides the detail of several protocols underneath: for example, FTP (File Transfer Protocol) and WebDAV (Web-based Distributed Authoring and Versioning). WebDAV is a set of extensions to the HTTP protocol which allows users to collaboratively edit and manage files on remote web servers. WebDAV is an IETF Proposed Standard (published as RFC 2518). Microsoft® WebFolders allows URL references to FTP and WebDAV sites to be manifested as visual folders, similar to the Explorer folders for the local file system. Although it has some restrictions that Windows® file folders don't have, Microsoft® WebFolders appears just like the folders users have in Explorer. Under the surface, however, Microsoft® WebFolders is a local interface to a remote resource.

Since the introduction of MS® Office 2003, Microsoft's® Office applications have consistently supported WebDAV, and Microsoft® WebFolders appear to be an integral part of the Microsoft® environment going forward. Microsoft® has embedded the WebFolders concept into its file system in a way that allows users to interact the same way with local folders, conventional network file folders and WebFolders that access content through the WebDAV and FTP protocols. WebFolders provides limited WebDAV support due to common denominator issues between WebDAV and FTP; for example, that not all customary right-click operations are accessible in WebFolders.

Microsoft® has been successful penetrating the work environment with Windows® and Office applications on the desktop.

Recognizing that most knowledge workers are already working with the familiar user interface paradigm of Microsoft® file folders, embodiments adopt the same paradigm to make the capabilities of a metadata repository ubiquitously available within enterprise environments.

An embodiment of a virtual folders application to expose the capabilities of a metadata repository via the WebDAV protocol is referenced herein as Flash Folders. Flash Folders allows easy access, submission, and maintenance of assets in a metadata repository. Flash Folders also provide a convenient way to collect artifacts that are to be physically housed in a metadata repository.

An embodiment socializes a metadata repository in the same way that Instant Messaging, RSS feeds and multimedia are socializing the Web with Web 2.0. In contrast to the more esoteric and technically-oriented UDDI v2 and v3 registry interfaces that a metadata repository already presents for Web services, Flash Folders make the entire content of a metadata asset repository “available to the masses” for publishing, access, and collaboration.

In addition to introducing the file folder user interface paradigm for metadata repository end users, an embodiment brings to bear metadata repository automation capabilities for publishing artifacts that are saved to a Flash Folder. Files that are saved or dragged to Flash Folders are treated automatically as asset submissions or updates, and the metadata respository's introspection and automated processing features take effect. For example, a WSDL file saved to a Flash Folder can be automatically introspected, created as a Web service asset, imported to the metadata repository and placed in the metadata repository directory. WSDL-referenced artifacts such as XML schemas, and XSD-referenced artifacts also become related assets in the metadata repository.

Consequently, Flash Folders are one of several “upstream” starting points to initiate fully-automated corporate governance of metadata repository content. Flash Folders provide a more casual or ad hoc front end to the submission and asset publishing process, but they also make it easier to collaboratively produce and maintain metadata repository assets. Users can decide whether to continue their current metadata repository asset submission and revision practices, or whether to replace or supplement them with the use of Flash Folders.

Flash Folders expose an interface into a metadata repository via an implementation of the industry standard WebDAV protocol. Microsoft's® WebFolders make access to the Flash Folder WebDAV interface a simple and familiar task for Windows users.

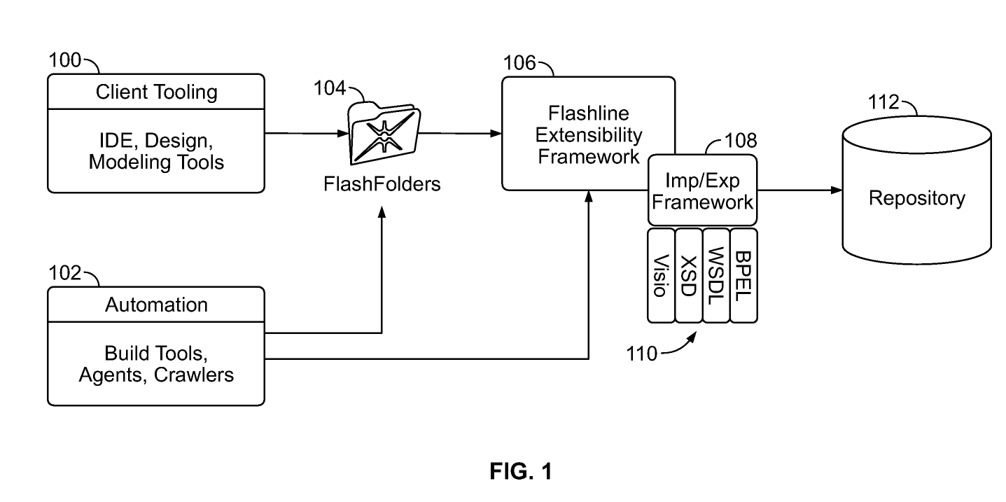

FIG. 1 illustrates a system architecture diagram, in accordance with one embodiment. Metadata Assets can be submitted through the Flash Folders 104 from a variety of sources, including client tooling 100 such as integrated development environments (IDE), design tools, and modeling tools, as well as from automated systems 102 such as build tools, agents, and crawlers. Once the metadata assets are submitted to the Flash Folders, the assets then are submitted through the Flashline Extensibility Framework (FLEX) 106 through the Import/Export framework 108 into the Metadata Repository 112.

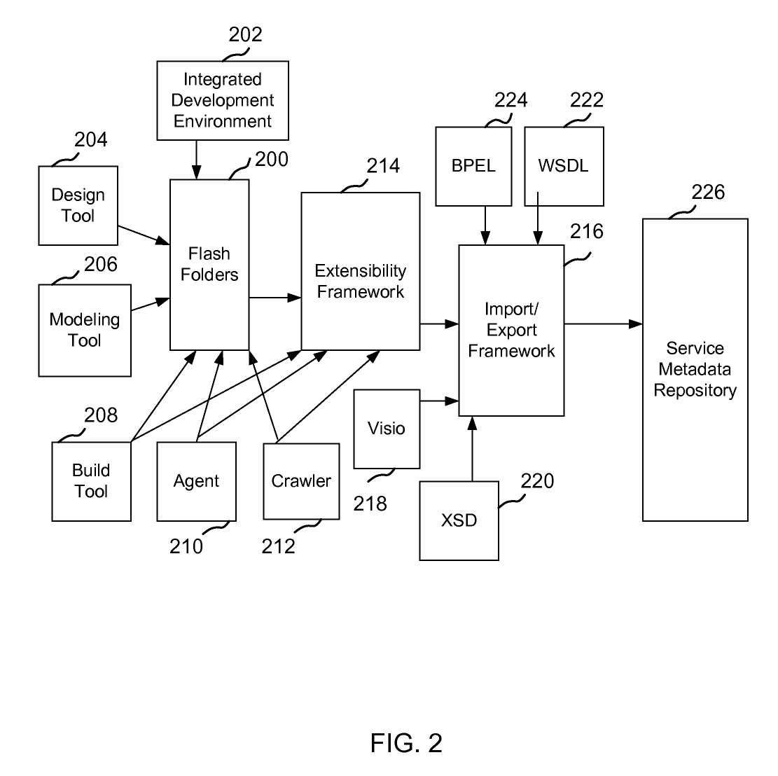

FIG. 2 illustrates a system architecture diagram, in accordance with one embodiment. Flash Folders 200 receives a service metadata file from an integrated development environment 202, a design tool 204, a modeling tool 206, a build tool 208, an agent 210, or a crawler 212. The Flash Folders 200 then introspects the service metadata file and passes the introspected information through the Extensibility Framework 214 through the Import Export Framework 216 into the Service Metadata Repository 226, where the introspected information is used to populate a service metadata asset associated with the service metadata file. The Extensibility Framework 214 can also receive service metadata directly from automated systems such as build tools, agents, and crawlers. The Import/Export Framework 216 provides capabilities to introspect Microsoft Visio® 218, XSD 220, WSDL 222, and BPEL 224 files.

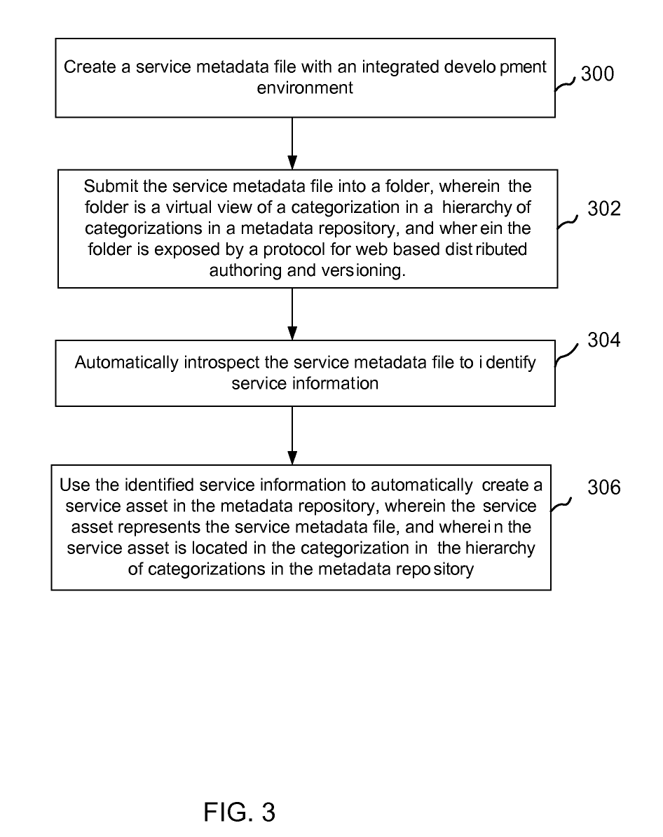

FIG. 3 illustrates a flowchart for a method, in accordance with one embodiment. In step 300, a WSDL file is created with an integrated development environment. In step 302, the WSDL file is submitted into a folder, wherein the folder is a virtual view of a categorization in a hierarchy of categorizations in a metadata repository, and wherein the folder is exposed by a protocol for web-based distributed authoring and versioning. In step 304, the WSDL file is automatically introspected to identify service information. In step 306, the identified service information is used to automatically create a service asset in the metadata repository, wherein the service asset represents the WSDL file, and wherein the service asset is located in the categorization in the hierarchy of categorizations in the metadata repository.

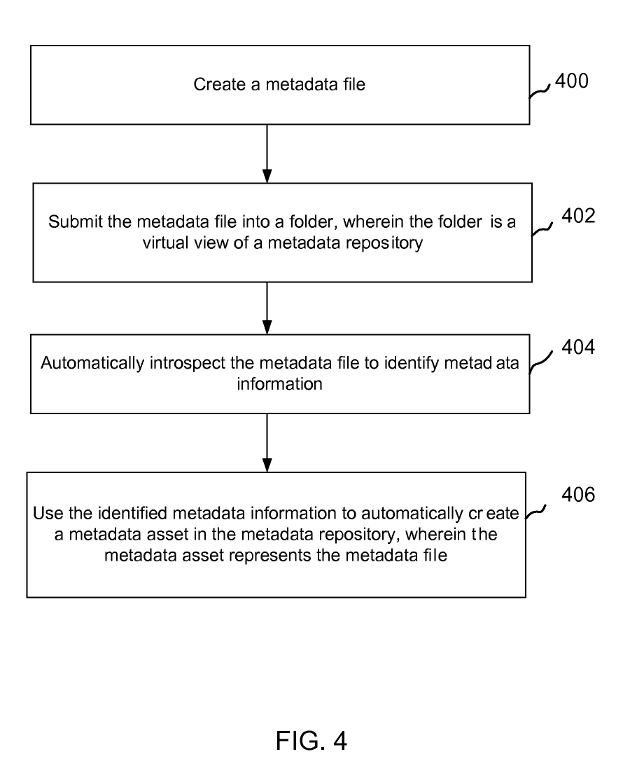

FIG. 4 illustrates a flowchart for a method, in accordance with one embodiment. In step 400, a metadata file is created. In step 402, the metadata file is submitted into a folder, wherein the folder is a virtual view of a metadata repository. In step 404, the metadata file is automatically introspected to identify metadata information. In step 406, the identified metadata information is used to automatically create a metadata asset in the metadata repository, wherein the metadata asset represents the metadata file.

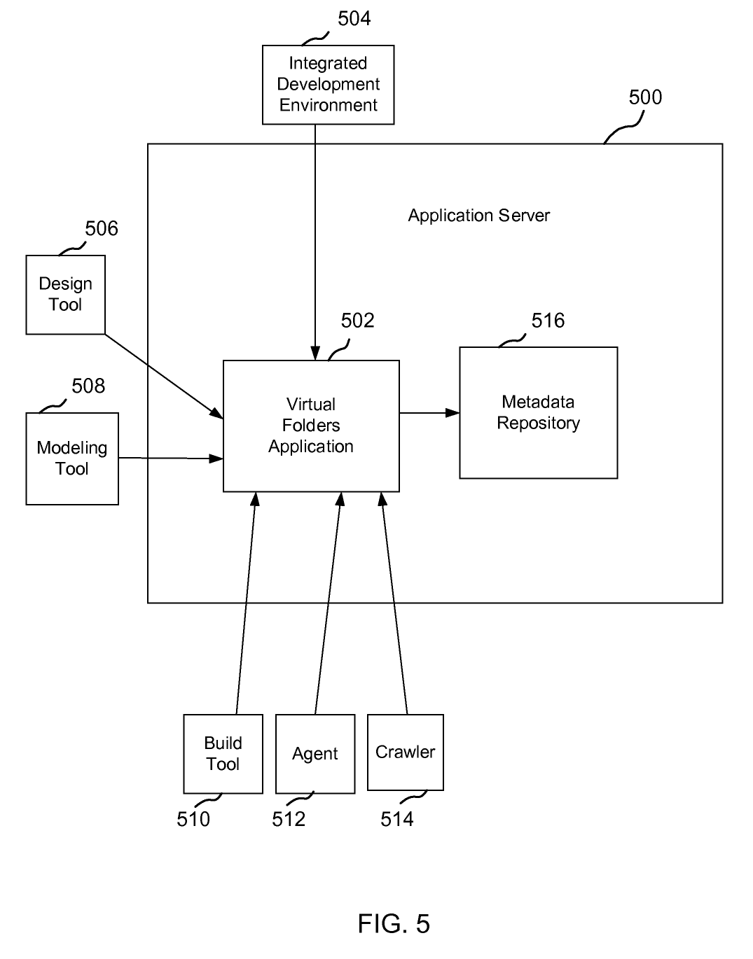

FIG. 5 illustrates a system architecture diagram, in accordance with one embodiment. Application Server 500 contains Virtual Folders Application 502 and Metadata Repository 516. Virtual Folders Application 502 receives a metadata file from a client application, such as integrated development environment 504, design tool 506, modeling tool 508, build tool 510, agent 512, or crawler 514. The metadata file is then introspected and passed into the metadata repository 516, where the introspected information is used to populate a metadata asset associated with the metadata file.

Benefits to users of the metadata repository include ubiquitous access to the metadata repository by users of an infinite variety of roles, including architects, executives, business users, and a wider variety of IT professionals beyond software engineering. Also provided is ease and rapidity of populating the metadata repository with assets of importance to users, through save-as and drag-and-drop features. Another benefit is simple harvesting from tools used throughout the enterprise, thereby fostering submission of assets. Another benefit is more frequent access to metadata repository content by prospective asset consumers, since Flash Folders are as accessible as local file folders are on the user's desktop. Flash Folders further provides easier maintenance and updates to existing metadata repository assets and a single place to house supporting artifacts that relate to metadata repository assets. Furthermore, Flash Folders enables instant understanding of how to interact with the metadata repository system and instant participation in an automated asset publishing process using the metadata repository's file introspection capabilities and workflow for asset submissions and revisions. Finally, there are virtually no metadata repository training requirements for non-administrators. In effect, users can share a Flash Folder as easily as they would share any other local file or network drive.

In one embodiment, the Flash Folders application is a small, separate web application. This Flash Folders application is typically deployed on the same application server that hosts the rest of the metadata repository, although other embodiments are contemplated. Because Flash Folders leverage a Web service API (published as part of the Flashline Extensibility Framework, or FLEX), the only item that must be configured in the Flash Folders web application at deployment time is the address of the Web service API.

In accordance with one embodiment, standard authentication mechanisms and access controls apply to Flash Folders. Login leverages HTTP or HTTPS authentication, and Active Directory (or LDAP) can optionally be employed for user authentication and role assignment. Based on login, users can have Flash Folder access only to the assets for which they have permissions granted. In one embodiment, access controls on individual asset files are not implemented in Flash Folders, and files are therefore accessible according to the access controls on the assets with which they are associated.

Flash Folders also allow access to the contents of the metadata assets. For example, if a user navigates to an asset through the folders, they can click on the asset to open the asset just as they would click on a file displayed through Windows® Explorer.

If consumer access to assets-in-progress is enabled in the metadata repository, then the user community can have access to both registered and unregistered assets through Flash Folders.

Flash Folders and Microsoft® WebFolders are based on a common standard—WebDAV. Flash Folders are a metadata repository implementation of WebDAV, which may be accessed as a set of WebFolders in the Microsoft® environment, but Flash Folders can also be accessed on other vendor platforms. In short, wherever the WebDAV protocol is supported, Flash Folders are accessible.

Numerous configuration options are supported. For example, using a WebDAV file system plugin, a user can mount a WebDAV location into the user's file system. The user can map the Flash Folders onto a network drive, go through network, or map to a drive folder. The user can Save as a metadata asset onto a network drive. The user can make an alias to the desktop Submit folder appear on the desktop as a shortcut to drag and drop.

The Flash Folders application can enforce workflow requirements and show only registered assets. Flash Folders can permit the submission of multiple files (allowing a user to drag and drop groups of files into or out of the metadata repository). The Flash Folders application also allows the ability to modify the payload directory in the metadata repository.

The Flash Folders application essentially creates a virtual file system that users can browse to submit, examine, and modify service metadata stored in the metadata repository. A hierarchy of categorizations that exist in the metadata repository can be traversed just as levels in a directory system are traversed. The user can drill down the hierarchy until they find the appropriate asset, which is then displayed as a series of XML and HTML files. All of the hierarchical concepts in the metadata repository are exposed through the WebDAV protocol to the user. This enables a user to retrieve metadata assets from the metadata repository without having to use a specialized client application that requires specialized user training. This also enables a user to easily submit content into the metadata repository, again without requiring extensive user training for a specialized client application. If a user wants to submit a new asset into the repository, the user just drills down into the folder and then drags and drops the asset information into the appropriate position in the hierarchy.

In one embodiment, the folders application can be configured to suppress some or all empty folders so that empty folders are not displayed to the user.

The three major uses of Flash Folders by users are expected to be: browsing assets in the metadata repository; submitting new files into the metadata data repository; and editing assets and artifacts in the metadata repository. Different security levels can be set for the XML associated with an asset. The Flash Folders application provides multi-user access, enabling access of Flash Folders by multiple users simultaneously. These users may be geographically dispersed and need to communicate through firewalls.

In one embodiment, the system queries the user during drag and drop when the user saves an asset to the Flash Folders from a design tool, and the user is prompted for an asset name, version, and description. In one embodiment, the user is queried for asset information when dragging and dropping a file into Flash Folders from any source.

In one embodiment, the Flash Folders application provides additional information to the user about the purpose of the individual folders. In one embodiment, the Flash Folders application generates an about.html file for each folder. In one embodiment, alphabetic breakdown is used to describe assets, i.e. if there are more than N assets, break down from A to AA, AF, AZ, etc.

In accordance with one embodiment, the following example describes how Flash Folders can be used. The user can open Flash Folders by clicking on an icon on their desktop, clicking on an icon in “My Network Places,” or navigating to a network location. The user can then create a new diagram asset with a design tool (for example, with Microsoft Visio ). The user can then create new shape assets. The user can then open the metadata repository menu in Microsoft Visio® (via a plug-in) and select “Refresh Stencil.” This user can then create a new Microsoft Visio® drawing, and then open the “new assets” stencil. The user can then drag shapes onto the canvas and respond to a prompt for asset data. The user can enter asset metadata (name, version, description) and add existing assets to the drawing. The user can then select search from the metadata repository menu in Microsoft Visio® by typing in keywords or selecting categorizations to find existing assets in the metadata repository. One example to search for is the “Asset Function” categorization type, with the “J2EE application servers” categorization selected. The user can then save the search as a stencil. The user can then drag shapes from the stencil onto the canvas. The user is not prompted for asset metadata because the asset already has its metadata populated (since the search found an already existing asset). The user can then create relationships between assets by selecting the “New Assets” stencil and selecting the “Bidirectional” connector shape on the stencil. The user can then drag the bidirectional shape onto the canvas and select the relationship type when prompted. Relationship types are pulled from the repository each time the stencil is refreshed. After attaching the ends of the bidirectional connector shape to different shapes on the drawing, the user can then save the diagram asset.

After creating and saving the asset, the user can then browse to the Windows® WebFolder that is connected to Flash Folders. The user can then select the file type, and browse to the appropriate directory in the hierarchy of categorizations. After saving the file in the virtual folder, the user can be prompted for requests for information about the asset.

Alternatively, instead of saving a newly created asset, the user can search for the asset in the directory by asset name. After finding the asset, the user can view the diagram asset in Flash Folders. The user can open the Windows® file explorer, and browse to the Flash Folders (possibly via Network Places or a shortcut). The user would then find the new diagram asset in the appropriate place in the hierarchy. The user can select the diagram, accept the diagram for submission purposes, and save the asset. The user can then refresh the payload directory, and examine the submitted asset. The user can also augment the asset by dragging and dropping additional associated files into asset sub-directories.

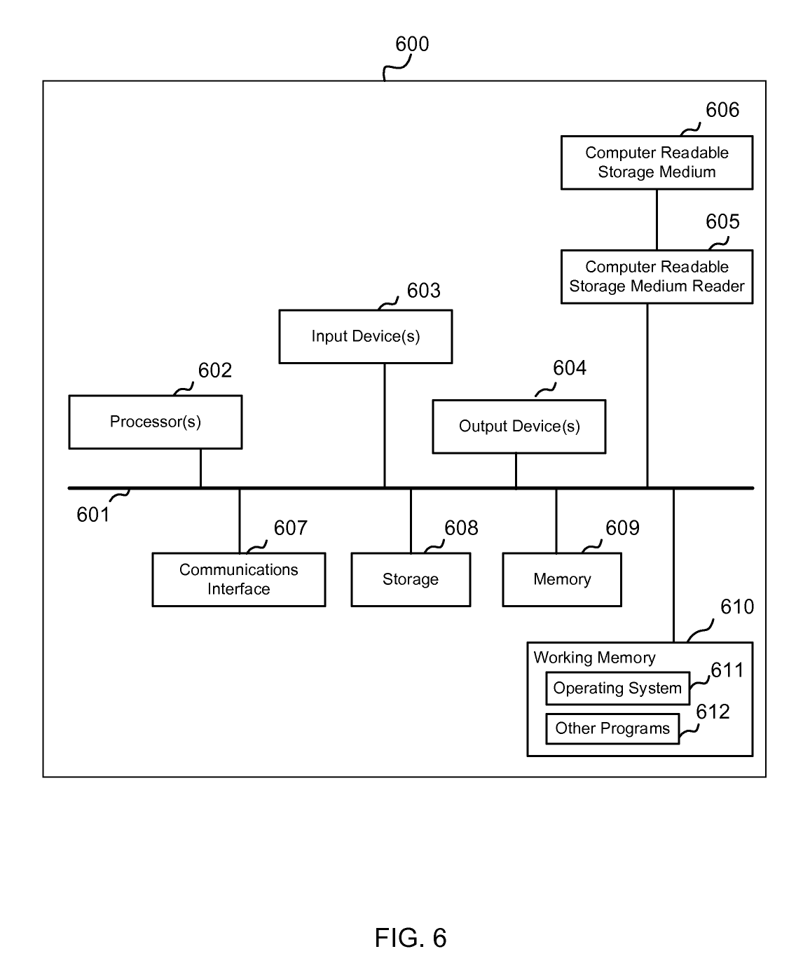

FIG. 6 illustrates an exemplary processing system 600, which can comprise one or more of the elements of FIG. 1, FIG. 2, and FIG. 5. While other alternatives might be utilized, it can be presumed that the components of the systems of FIG. 1, FIG. 2, and FIG. 5 are implemented in hardware, software or some combination by one or more computing systems consistent therewith, unless otherwise indicated.

Computing system 600 comprises components coupled via one or more communication channels (e.g., bus 601) including one or more general or special purpose processors 602, such as a Pentium®, Centrino®, Power PC®, digital signal processor (“DSP”), and so on. System 600 components also include one or more input devices 603 (such as a mouse, keyboard, microphone, pen, and so on), and one or more output devices 604, such as a suitable display, speakers, actuators, and so on, in accordance with a particular application. (It can be appreciated that input or output devices can also similarly include more specialized devices or hardware/software device enhancements suitable for use by the mentally or physically challenged.)

System 600 also includes a computer readable storage media reader 605 coupled to a computer readable storage medium 606, such as a storage/memory device or hard or removable storage/memory media; such devices or media are further indicated separately as storage 608 and memory 609, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 607 may also be included, such as a modem, DSL, infrared, RF or other suitable transceiver, and so on for providing inter-device communication directly or via one or more suitable private or public networks or other components that may include but are not limited to those already discussed.

Working memory 610 further includes operating system (“OS”) 611 elements and other programs 612, such as one or more of application programs, mobile code, data, and so on for implementing system 600 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 612 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 608 or memory 609) in accordance with a particular application. Embodiments can include computer-based methods and systems which may be implemented using a conventional general purpose computer(s) or a specialized digital computer(s) or microprocessor(s), programmed according to the teachings of the present disclosure. Appropriate software coding can readily be prepared by programmers based on the teachings of the present disclosure.

Embodiments can include a computer readable medium, such as a computer readable storage medium. The computer readable storage medium can have stored instructions which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory or any media or device suitable for storing instructions and/or data. The present invention can include software for controlling the hardware of a computer, such as a general purpose/specialized computer(s) or a microprocessor(s), and for enabling them to interact with a human user or other mechanism utilizing the results of the present invention. Such software may include, but is not limited to, device drivers, operating systems, execution environments/containers, and user applications.

Embodiments can include providing code for implementing processes. The providing can include providing code to a user in any manner. For example, the providing can include transmitting digital signals containing the code to a user; providing the code on a physical media to a user; or any other method of making the code available.

Embodiments can include a computer-implemented method for transmitting the code which can be executed at a computer to perform any of the processes of embodiments. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

The foregoing description of preferred embodiments has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A method, comprising:
creating a service metadata file with an integrated development environment;
submitting the service metadata file into a folder, wherein the folder is a virtual view of a categorization in a hierarchy of categorizations in a metadata repository, and wherein the folder is exposed by a protocol for web-based distributed authoring and versioning;
automatically introspecting the service metadata file to identify service information; and
using the identified service information to automatically create a service asset in the metadata repository, wherein the service asset represents the service metadata file, and wherein the service asset is located in the categorization in the hierarchy of categorizations in the metadata repository.

2. The method of claim 1, wherein a file that is saved or dragged to a folder is treated automatically as an asset submission or update.

3 . The method of claim 2, wherein the metadata repository's introspection and automated processing takes effect when a file is saved or dragged to the folder.

4. The method of claim 1, wherein the folders application communicates to the metadata repository through a web service API.

5. The method of claim 1, wherein a WSDL file saved to a folder is automatically introspected, created as a web service asset, imported to the metadata repository, and placed in the metadata repository directory.

6. The method of claim 5, wherein WSDL-referenced artifacts become related assets in the metadata repository.

7. The method of claim 6, wherein the WSDL-referenced artifacts include XML schemas and XSD-referenced artifacts.

8. A computer-readable storage medium, including instructions stored thereon which when read and executed by a computer cause the computer to perform steps comprising:
creating a service metadata file with an integrated development environment;
submitting the service metadata file into a folder, wherein the folder is a virtual view of a categorization in a hierarchy of categorizations in a metadata repository, and wherein the folder is exposed by a protocol for web-based distributed authoring and versioning;
automatically introspecting the service metadata file to identify service information; and
using the identified service information to automatically create a service asset in the metadata repository, wherein the service asset represents the service metadata file, and wherein the service asset is located in the categorization in the hierarchy of categorizations in the metadata repository.

9. The computer-readable storage medium of claim 8, wherein a file that is saved or dragged to a folder is treated automatically as an asset submission or update.

10. The computer-readable storage medium of claim 9, wherein the metadata repository's introspection and automated processing takes effect when a file is saved or dragged to the folder.

11. The computer-readable storage medium of claim 8, wherein the folders application communicates to the metadata repository through a web service API.

12. The computer-readable storage medium of claim 8, wherein a WSDL file saved to a folder is automatically introspected, created as a web service asset, imported to the metadata repository, and placed in the metadata repository directory.

13. The computer-readable storage medium of claim 12, wherein WSDL-referenced artifacts become related assets in the metadata repository.

14. The computer-readable storage medium of claim 13, wherein the WSDL-referenced artifacts include XML schemas and XSD-referenced artifacts.

15. A computer-based system for ubiquitous access to a metadata repository, comprising:
a metadata repository on an application server, wherein the metadata repository stores metadata assets that represent service metadata files;
a folders application on the application server, wherein the folders application supports a protocol for web-based distributed authoring and versioning;
wherein a user uses a client machine to access metadata assets stored in the metadata repository; and
wherein the service metadata is displayed through folders to the user.

16. The computer-based system of claim 15, wherein a file that is saved or dragged to a folder is treated automatically as an asset submission or update.

17. The computer-based system of claim 16, wherein the metadata repository's introspection and automated processing takes effect when a file is saved or dragged to the folder.

18. The computer-based system of claim 15, wherein the folders application communicates to the metadata repository through a web service API.

19. The computer-based system of claim 15, wherein a WSDL file saved to a folder is automatically introspected, created as a web service asset, imported to the metadata repository, and placed in the metadata repository directory.

20. The computer-based system of claim 19, wherein WSDL-referenced artifacts become related assets in the metadata repository.
